(19) United States
(12) Patent Application Publication
(10) Pub. No.: US 2004/0159239 A1
(43) Pub. Date: Aug. 19, 2004

(54) Multi-phase HVAC filtration system

(76) Inventor: Daniel A. Nagem, Baton Rouge, LA (US)

Correspondence Address: Roy, Kiesel, Keegan and DeNicola, 2355 Drusilla Lane, P.O. Box 15928 (70895-5928), Baton Rouge, LA, 70809, US

(21) Appl. No.: 10/367,305

(22) Filed: Feb. 14, 2003

(51) Int. Cl. B01D 46/00

(52) U.S. Cl. 96/134; 96/222; 96/223; 55/485; 55/486

(57) ABSTRACT

According to the present invention, the multi-phase HVAC filtration system provides a unitary device which performs basic filtration, odor-elimination, high-efficiency filtration and adds fragrance to the climate-controlled area.

### BACKGROUND OF THE INVENTION

The present invention relates to the multi-stage filtering of return air in an HVAC (Heating, Ventilation and Air Conditioning) climate-control system.

A typical HVAC system implements a filter at the intake, or as it is commonly referred to, the return, which is primarily for the purpose of keeping the condenser coils of the air conditioner clean. Secondarily, the purpose of the filter is to help eliminate airborne debris in the area sought to be climate controlled, however, this filtration is not particularly efficient.

Thus, the removal of airborne contaminants is one area in need of improvement in existing filter designs. Current filtration systems do not remove a substantial portion of the airborne contaminants, nor do they condition the air to remove odors, which in the current art, pass uninhibited back into the climate controlled environment. This can pose a problem for those who are sensitive to airborne pollutants, as well as those areas which are in need of odor control, as well as being a nuisance to users of filtration systems who desire cleaner, fresher air.

This problem can be overcome by using external filtration systems, or large, ceiling-mounted apparatus. These systems are inferior to the current invention in that they are often expensive, take up additional living area and require additional electricity, all yielding a higher cost, whether it be in physical space or resources.

Another area in need of revision in the filtering industry is methods of scenting the environment. While known in the prior art, fragrance enhancers currently add a fragrance by complementing existing filtration systems and are not designed to condition a substantial portion of the air passing through the system. Also, most air fragrance systems simply add odor to a portion of the air without any filtration actually taking place.

The current invention fills the existing gap in technology by providing a filtration system which performs basic plus advanced filtration, active chemical filtration, and HEPA (High Efficiency Particulate Air) filtration. In addition, one layer can be a scented layer to affect odor control in the climate controlled area by filtering the air flow through the device in its entirety. The current devices in this field do not offer the unique combination of basic, advanced, and odor filtration coupled with fragrance introduced as in the configuration presented herein.

### OBJECTS OF THE INVENTION

One object of the invention is to provide a device capable of multi-stage filtration for HVAC systems.

Another object of this invention is to provide a device capable of affecting basic filtration, odor control and HEPA filtration in one unit.

Still another object of the invention is to provide a device which employs a multi-stage filtration system with a scented layer for odor control of the climate-controlled area.

Other objects and advantages of this invention shall become apparent from the ensuing descriptions of the invention.

### SUMMARY OF THE INVENTION

According to the present invention, the multi-phase HVAC filtration system provides a unitary device which performs basic filtration, odor-elimination, high-efficiency filtration and adds fragrance to the climate-controlled area.

### BRIEF DESCRIPTION OF THE DRAWINGS

The accompanying drawings illustrate an embodiment of this invention. However, it is to be understood that this embodiment is intended to be neither exhaustive, nor limiting of the invention. They are but examples of some of the forms in which the invention may be practiced.

FIG. 1 shows a perspective exploded view of the multi-phase HVAC filtration system.

FIG. 2 shows a side cutaway view of the multi-phase HVAC filtration system.

FIG. 3 shows a partial front view of the multi-phase HVAC filtration system as part of an HVAC system.

### DETAILED DESCRIPTION OF EXEMPLARY EMBODIMENTS

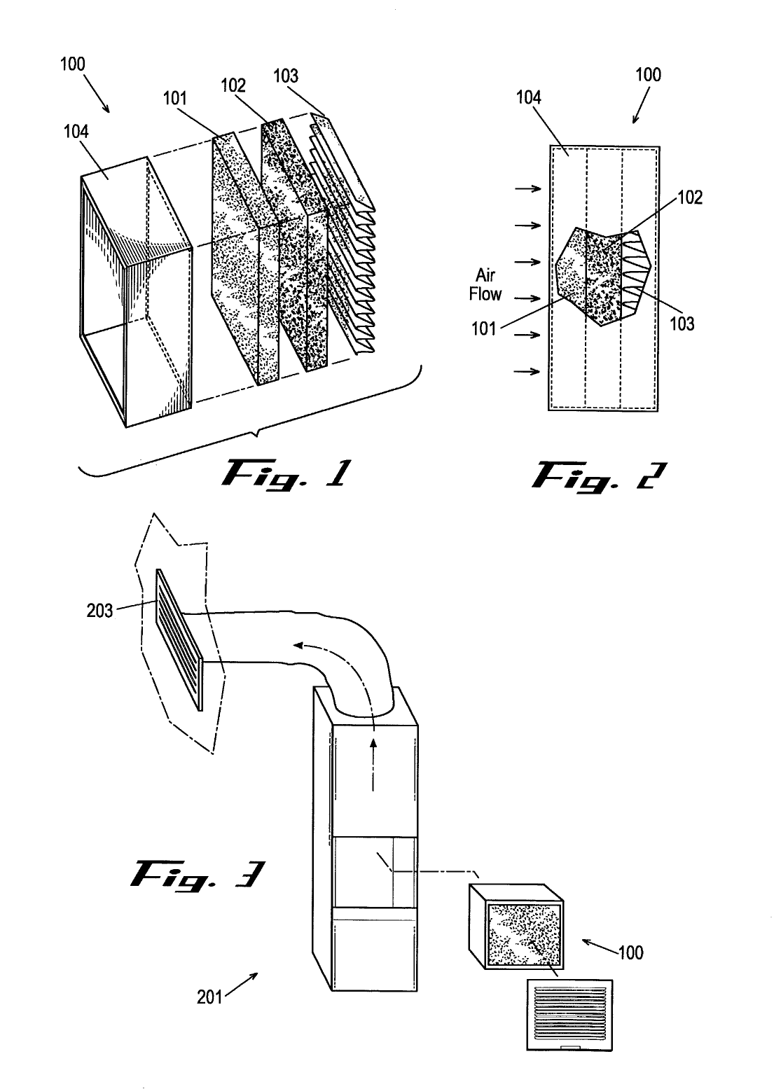

Without any intent to limit the scope of this invention, reference is made to the figures in describing the various embodiments of the invention. Referring to FIGS. 1 through 3, multi-phase HVAC filtration system 100 is pictured.

Multi-phase HVAC filtration system 100 is pictured with three filter elements 101 102 103 enclosed in filter casing 104. Three filter elements 101 102 103 are arranged in series, or one immediately after the other, such that any air flowing through filter casing 104 must flow through each element in order to flow completely through multi-phase HVAC filtration system 100. Filter elements 101, 102, 103 are arranged first through third such that first filter element 101 is the filter element which comes in contact with the air initially, followed by second filter element 102, and finally flows through third filter element 103.

First filter element 101 is usually a fibrous material, such as fiberglass or polyester. This material may also be any other stranded filter media capable of filtering large airborne particulate matter.

Second filter element 102 is typically an odor-eliminating material such as activated carbon, or carbon that has been heated to increase its absorption capacity, which is capable of removing odors from air by chemically absorbing odors and toxins as the air passes through the activated carbon layer.

Third filter element 103 is preferably a high-efficiency filtering material, or a HEPA filter, capable of removing microorganisms from the air. These filters are often pleated in order to increase the surface area in a given space. Additionally, these filters can aid in eliminating mold spores and other materials, which when left uncontrolled, can actually use an HVAC system to redistribute themselves across a home, effectively encompassing a whole living area.

Any one of filter elements 101, 102, 103 may be impregnated with a fragrance as well. This impregnation can be by various means, such as spraying, soaking, or otherwise imbedding a desired scented material or chemical into filter elements 101, 102, 103. Scent can be of various types, such as floral, food or neutralizing. Such a fragrance can be of particular use in a malodorous area, adding a desired scent to mask or replace an undesirable one.

Additional filter elements can be added as the application requires, in addition to the filter elements presented herein, as well as the possibility of replacing one or more of the filter elements herein with other types of filtering material or changing the order of the filter elements.

In operation, multi-phase HVAC filtration system 100 is placed at the return inlet of HVAC system 201, or the portion of HVAC system 201 wherein air is introduced to HVAC system 201, prior to being altered and directed into a climate-controlled space 203.

Once positioned at the return, air is drawn through the filtration system 100 by a fan or other air-moving apparatus which is part of HVAC system 201. While flowing through first filter element 101, the fibrous material intercepts and traps various large pieces of particulate matter that may be present in the air being climate controlled, such as pet dander, dust, and other large particles.

After air flows through first filter element 100, it begins to be drawn through second filter element 102. At this point, air can be purged of odor impurities and gases that may be present, such as pet odor, tobacco smoke, cooking odors or the like. This purifies the air by the chemical process mentioned previously, as the air passes through the activated carbon.

Once the air is completed flowing through second filter element 102, the air will be drawn through third filter element 103. It is at this point that allergens, microorganisms, mold bacteria and the like are trapped in third filter element 103. This filter element can, and often will, be a HEPA filter, capable of removing very small particulate matter. This is particularly useful for those users of filtration system 100 who have allergies, as many known allergens can be trapped and substantially reduced by the use of a HEPA filter.

During the course of air's travel through filtration system 100, any of filter elements 101, 102, 103, if impregnated with a fragrance, will add such fragrance to the air as it flows through the corresponding filter element 101, 102, 103, thus deodorizing the area sought to be filtered.

Upon flowing through all three filter elements in series, the air drawn into the HVAC system's climate control area, and the discharged into the area sought to be climate-controlled via ducts 202. This cycle is repeated so long as HVAC's 201 circulating system is operating. In this fashion, the same air can be circulated through HVAC system 201 so that via multiple passes, the air can be continuously purified as additional contaminants are added to the air within the system, whether it be by people, pets or other contaminant sources. If in a closed system, these multiple cycles of air achieve an increasingly purified environment, up to the maximum effectiveness of the particular filter media used.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

The invention claimed is:

1. A multi-phase HVAC filtration system comprising
a. at least three filter elements arranged in series and enclosed in a casing
i. wherein one of said filter elements is comprised of a fibrous material;
ii. wherein another of said filter elements is comprised of an odor-absorbing material;
iii. wherein another of said filter elements is comprised of a high-efficiency microorganism filter element.

2. A multi-phase HVAC filtration system according to claim 1 wherein said fibrous material is fiberglass.

3. A multi-phase HVAC filtration system according to claim 1 wherein said fibrous material is polyester.

4. A multi-phase HVAC filtration system according to claim 1 wherein said odor-absorbing material is carbon.

5. A multi-phase HVAC filtration system according to claim 1 wherein said high-efficiency microorganism filter element is a HEPA filter element.

6. A multi-phase HVAC filtration system according to claim 1 wherein said filtration system is configured to be placed at the return opening of said HVAC system.

7. A multi-phase HVAC filtration system comprising
a. at least three filter elements arranged in series and enclosed in a casing,
i. wherein one of said filter elements is comprised of a fibrous material capable of trapping particulate matter;
ii. wherein another of said filter elements is comprised of an odor-absorbing material;
iii. wherein another of said filter elements is comprised of a high-efficiency microorganism filter element; and
b. a scented material positioned in series with said filter elements and capable of adding fragrance to a substantial portion of the air passing through said filtration system.

8. A multi-phase HVAC filtration system according to claim 7 wherein said scented material is impregnated in at least one of said first, second, or third filter elements.

9. A multi-phase HVAC filtration system according to claim 7 wherein said fibrous material is fiberglass.

10. A multi-phase HVAC filtration system according to claim 7 wherein said fibrous material is polyester.

11. A multi-phase HVAC filtration system according to claim 7 wherein said odor-absorbing material is carbon.

12. A multi-phase HVAC filtration system according to claim 7 wherein said high-efficiency microorganism filter element is a HEPA filter element.

13. A multi-phase HVAC filtration system according to claim 7 wherein said filtration system is configured to be placed at the return opening of said HVAC system.

14. A multi-phase HVAC filtration system configured to be mounted at the return inlet of an HVAC system comprising
a. a filter casing;
b. a first filter element comprising a fibrous material capable of trapping particulate matter;
c. a second filter element comprising an odor-absorbing material;
d. a third filter element comprising a high-efficiency microorganism filter element; and
e. a scented material impregnated in at least one of said first, second, or third filter elements.

15. A multi-phase HVAC filtration system according to claim 14 wherein said fibrous material is fiberglass.

16. A multi-phase HVAC filtration system according to claim 14 wherein said fibrous material is polyester.

17. A multi-phase HVAC filtration system according to claim 14 wherein said odor-absorbing material is carbon.

18. A multi-phase HVAC filtration system according to claim 14 wherein said high-efficiency microorganism filter element is a HEPA filter element.

19. A multi-phase HVAC filtration system according to claim 14 wherein said filtration system is configured to be placed at the return opening of said HVAC system.
